(19) United States
(12) Patent Application Publication
(10) Pub. No.: US 2025/0267435 A1
(43) Pub. Date: Aug. 21, 2025

(54) Network Station Identification Based On Geodetic Datum

(71) Applicant: Bradford T Hite, Valencia, CA (US)

(72) Inventor: Bradford T Hite, Valencia, CA (US)

(21) Appl. No.: 18/581,819

(22) Filed: Feb. 20, 2024

(51) Int. Cl. H04W 4/44; H04W 4/029

(52) U.S. Cl. CPC H04W 4/44; H04W 4/029

(57) ABSTRACT

A unique system for the implementation of a communications system whereby network communicators such as service providers and service users are accessed based on geodetic datum. Service providers broadcast geodetic based network identification information on a common control channel for reception by local proximity service users. The service user evaluates each received broadcast and determines if a secure paired network connection is required. The encoded data link is negotiated between user/provider for secure data transmission based on current geodetic network identification information. Geodetic information, being temporary in nature, can be propagated in position, time or both to provide dynamically updating network identification for any participant.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCES CITED

### U.S. Patent Documents

U.S. Pat. No. 9,140,782 B2 September 2015 Alberth

### Foreign Patent Documents

Not Applicable

### OTHER PUBLICATIONS

Not Applicable

### BACKGROUND OF THE INVENTION

### 1. Field of the Invention

This invention relates to the field of providing a unique network identification or address for network communicators based on their geodetic datum parameters. Based on real time global navigation satellite system (GNSS) data, each communicator will have a unique set of geodetic datum parameters representing a precise location at an instant in time. These parameters are used to derive a communicator network identification having the properties of uniqueness, temporary persistence and one-time usage. Communicator identification can be used to uniquely encode/access a data link or channel to insure a secure paired communication path between network communicators. The invention is compatible with current methods of communications but in most cases will serve to simplify mobile network overhead management.

### 2. Description of the Related Art

Providing secure data communications between non stationary users presents a difficult situation due to the operational environment dynamics. Channels need to be dynamically allocated based on proximity and interaction requirements possibly forming multiple overlapping competing local networks. Additionally, secure data transmission adds in the need for cryptographic key content management outside of network channel management. These areas are being currently being investigated as part of an industry standard mobile network configuration. The present invention is a system and method to address these unmet needs.

Current industry acceptance of IEEE 802.11p and IEEE 1609 define a WAVE (Wireless Access in Vehicular Environments) network protocol stack specialized for vehicle communications. Further, SAE J2735 defines the specific messaging formats and structure for vehicle/vehicle (V2V) or vehicle/infrastructure (V2I) applications. These applications, as described in SAE J2945, are mainly centered on vehicle safety and interaction within traffic situations to provide a method to exchange information. The SAE J2735 protocol is built around a core message type called the “Basic Safety Message” openly broadcast by each vehicle. This message is broadcast by vehicles to provide situational data including location, heading, speed, etc to surrounding vehicles. Being an open broadcast with no security provisions, the messages are non-secure being susceptible to bad actor spoofing. Local V2V type continuous data transactions over an IEEE 801.11p network are provided by the Non-IP based the CALM-FAST protocol. Although Non-IP based, the protocol is based on MAC addressing whereby each network participant is identified by a unique static 48 bit MAC address. The present invention teaches a system whereby each network participant is identified by their unique real time geodetic (position/time) datum. Network identification derived from ever changing geodetic information has deterministic properties of being unique, usable for a temporary period and one time generation based the fact two communicators cannot occupy the same physical space at the same time. Geodetic datum can be propagated in position, time or both to provide dynamically updating network identification for any participant. Periodically changing or updating of each network participant's identification information based on the latest geodetic datum provides a secure method for network data communications.

Ad-hoc V2V communication systems have been proposed in the art most notably by Alberth in U.S. Pat. No. 9,140,782 titled “Inter-Vehicle Alert System with Nagable Video Look Ahead”. The system of Alberth utilizes millimeter wave radar sensors mounted front/rear to send video data between vehicles for collision avoidance. Communication between vehicles is simply based on “addressing information” whereby no further description is provided. This is different from the generalized geodetic based network identification data links proposed by the present invention whereby the system of Alberth is specialized to radar sensors and video type data.

### BRIEF SUMMARY OF THE INVENTION

The present invention comprises a communications system whereby network communicators such as service providers and service users are accessed using network identification based on geodetic datum. Service providers can broadcast geodetic based network identification information on a common control channel for reception by local proximity service users. Each service user evaluates received broadcasts and determines if a secure paired network connection is required. The encoded data link is negotiated between user/provider for secure data transmission based on current geodetic network identification information. Geodetic information, being temporary in nature, can be propagated in position, time or both to provide dynamically updating network identification for any participant.

### BRIEF DESCRIPTION OF THE DRAWINGS

FIG. 1 is a system block diagram for the preferred embodiment of the present invention.

FIG. 2 is a communication block diagram for the preferred embodiment of the present invention.

FIG. 3 is an example process diagram detailing the establishment of an encoded channel.

FIG. 4 is an example block diagram detailing the encoder hardware circuit.

FIG. 5 is an example block diagram detailing the decoder hardware circuit.

FIG. 6 is an example software flow chart detailing a service provider station control software processing steps.

FIG. 7 is an example software flow chart detailing the service user station control software processing steps.

REFERENCE NUMERALS IN THE DRAWINGS

| | | | |
|---|---|---|---|
| 100 | Vehicle #1 | 102 | Fixed Station |
| | Communicator | | Communicator |
| 104 | Vehicle #2 | 106 | Vehicle #3 |
| | Communicator | | Communicator |
| 108 | Vehicle #1 Control | 110 | Vehicle #1 to Fixed |
| | Channel Broadcast | | Station Encoded Data |
| | | | Link |
| 112 | Vehicle #1 to | 114 | Vehicle #1 to Vehicle |
| | Vehicle #2 Encoded | | #3 Encoded Data Link |
| | Data Link | | |
| 116 | Vehicle #2 to | 118 | Vehicle #2 to Fixed |
| | Vehicle #3 Encoded | | Station Encoded Data |
| | Data Link | | Link |
| 120 | Fixed Station Control | 122 | Vehicle #2 Control |
| | Channel Broadcast | | Channel Broadcast |
| 124 | Vehicle #3 Control | 126 | Vehicle #3 to Fixed |
| | Channel Broadcast | | Station Encoded Data |
| | | | Link |
| 128 | GNSS Signal | | |
| 200 | Vehicle #1 | 202 | Fixed Station |
| | Communicator | | Communicator |
| 204 | Remote Vehicle #3 | 206 | Remote Vehicle #2 |
| | Communicator | | Communicator |
| 208 | Fixed Station GNSS | 210 | Remote Vehicle #2 |
| | Signal | | GNSS Signal |
| 212 | Remote Vehicle #3 | 214 | Remote Vehicle #2 |
| | GNSS Signal | | Pos/Time/ID Control |
| | | | Channel Broadcast |
| 216 | Vehicle #1 to Fixed | 218 | Remote Vehicle #2 to |
| | Station Encoded Data | | Vehicle #1 Encoded Data |
| | Channel | | Channel |
| 220 | Remote Vehicle #3 to | 222 | Fixed Station to |
| | Vehicle #1 Encoded | | Vehicle #1 Data Link |
| | Data Channel | | Request Control |
| | | | Channel Transmission |
| 224 | Vehicle #1 | 226 | Vehicle #1 to Remote |
| | Pos/Time/ID | | Vehicle #3 Data Link |
| | Control Channel | | Request Control |
| | Broadcast | | Channel Transmission |
| 228 | Remote Vehicle #3 | 230 | Vehicle #1 to Remote |
| | Pos/Time/ID | | Vehicle #2 Data Link |
| | Control Channel | | Request Control |
| | Broadcast | | Channel Transmission |
| 232 | Vehicle #1 GNSS | | |
| | Signal | | |
| 300 | Service Provider Out | 302 | Determine Current |
| | Going Event | | Pos/Time/Id |
| | | | Information |
| 304 | Public Cryptographic | 306 | Data Encryption |
| | Key | | |
| 308 | Broadcast Pos/Time/ID | 310 | Re-Transmit Delay |
| | On Control Channel | | Period Timer |
| 312 | Service User In Coming | 314 | Receive Pos/Time/ID |
| | Event | | Info Broadcast |
| 316 | Private Cryptographic | 318 | Data Decryption |
| | Key | | |
| 320 | Determine Data Link | 322 | Transmit Data Link |
| | Parameters | | Request On Control |
| | | | Channel |
| 324 | Service Provider In | 326 | Receive Data Link |
| | Coming Event | | Request Transmission |
| 328 | Establish Pos/Time | 330 | Queue Data Link |
| | Encoded Data Link | | Frame Based Data |
| | | | Blocks |
| 332 | Start Epoch Frame | 334 | Service User In |
| | Transmission | | Coming Event |
| 336 | Establish Pos/Time | 338 | Start Epoch Frame |
| | Encoded Data Link | | Reception |
| 340 | Synchronize Epoch | 342 | Start Data Block |
| | Frame Reception | | Reception |
| 400 | GNSS Receiver | 402 | Control Channel |
| | | | Modem |
| 404 | Control Channel | 406 | Control Channel |
| | Transmitter | | Receiver |
| 408 | Encoded Data Link | 410 | Processor |
| | Transmitter | | |
| 412 | Latitudinal Based | 414 | Pseudo Random |
| | PRN Seed | | Binary Sequence |
| | | | Generator |
| 416 | Longitudinal Based | 418 | Pseudo Random |
| | PRN Seed | | Binary Sequence |
| | | | Generator |
| 420 | Temporal Based | 422 | Pseudo Random |
| | PRN Seed | | Binary Sequence |
| | | | Generator |
| 424 | Self ID Based PRN | 426 | Pseudo Random |
| | Seed | | Binary Sequence |
| | | | Generator |
| 428 | PRBS Output | 430 | PRBS Data Stream |
| | Combiner | | Combiner |
| 432 | Control Software | 434 | Encoded Data Stream |
| 500 | GNSS Receiver | 502 | Control Channel |
| | | | Modem |
| 504 | Control Channel | 506 | Control Channel |
| | Transmitter | | Receiver |
| 508 | Processor | 510 | Latitudinal Based PRN |
| | | | Seed |
| 512 | PRBS Output | 514 | PRBS Remover |
| | Combiner | | |
| 516 | Pseudo Random | 518 | Longitudinal Based |
| | Binary Sequence | | PRN Seed |
| | Generator | | |
| 520 | Encoded Data Link | 522 | Pseudo Random |
| | Receive | | Binary Sequence |
| | | | Generator |
| 524 | Temporal Based | 526 | Pseudo Random |
| | PRN Seed | | Binary Sequence |
| | | | Generator |
| 528 | Self ID Based PRN | 530 | Pseudo Random |
| | Seed | | Binary Sequence |
| | | | Generator |
| 532 | Control Software | 534 | Encoded Data Stream |
| 600 | Initialize Program | 602 | Initialize Modem |
| | Variables Process | | Interface Process Step |
| | Step | | |
| 604 | Broadcast | 606 | Channel Request |
| | Pos/Time/ID Event | | Received Decision |
| | Decision Block | | Block |
| 608 | Re-synch Data Link | 610 | Get GNSS Information |
| | Event Decision | | Process Step |
| | Block | | |
| 612 | Broadcast | 614 | Determine Data Link |
| | Pos/Time/ID On | | Parameters Process |
| | Control Channel | | Step |
| | Process Step | | |
| 616 | Establish | 618 | Queue Link Frame |
| | Pos/Time/ID | | Based Data Blocks |
| | Encoded Data Link | | Process Step |
| | Process Step | | |
| 620 | Start Epoch Frame | 622 | Get GNSS Information |
| | Transmission | | Process Step |
| | Process Step | | |
| 624 | Insert Pos/Time/ID | 626 | Update Pos/Time/ID |
| | In Last Epoch | | Encoded Data Link |
| | Process Step | | Process Step |
| 700 | Initialize Program | 702 | Initialize Modem |
| | Variables Process | | Interface Process Step |
| | Step | | |
| 704 | Receive | 706 | Encoded Channel |
| | Pos/Time/ID Event | | Active Decision Block |
| | Decision Block | | |
| 708 | Re-synch Data Link | 710 | Encoded Channel |
| | Event Decision | | Required Decision |
| | Block | | Block |
| 712 | Transmit Channel | 714 | Establish Pos/Time/ID |
| | Request on Control | | Encoded Data Link |
| | Channel Process | | Process Step |
| | Step | | |
| 716 | Start Epoch Frame | 718 | Synch Epoch Frame |
| | Reception Process | | Reception Process |
| | Step | | Step |
| 720 | Start Data Block | 722 | Retrieve Latest |
| | Reception Process | | Pos/Time/ID In Last |
| | Step | | Epoch Process Step |
| 724 | Update | 726 | Evaluate Pos/Time/ID |
| | Pos/Time/ID | | Parameters Process |
| | Encoded Data Link | | Step |
| | Process Step | | |

### DETAILED DESCRIPTION OF THE INVENTION

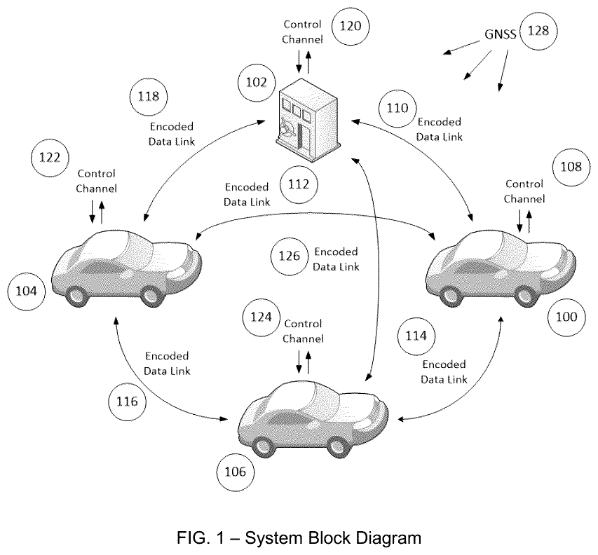

The preferred embodiment system block diagram of the present invention is shown in FIG. 1 as three mobile vehicle communicator stations and a fixed position communicator station. In the context of this preferred embodiment the terms pos/time/ID and identification information are used interchangeably. Each communicator station is equipped to receive GNSS information 128. Vehicle communicator station 100 accesses common control channel 108 to initially broadcast a data packet representing network identification information to include for example current position, time and self identification. The common control channel is available to all network communicators for open broadcasts or other type data transactions. Network identification information is analogous to an address uniquely identifying the communicator on the network. The self identification can further comprise a cryptographic key to allow encryption/decryption of network communications. FIG. 1 shows other local proximity communicator stations as vehicle 104, vehicle 106 and fixed station 102 whereby each receive the vehicle 100 network identification information broadcast. Common control channel access points for each is of the local communicator are identified by vehicle 104 as node 122, vehicle 106 as node 124 and fixed station 102 as node 120. Based on the vehicle 100 broadcast, each local communicator will determine if an encoded data link is required. An encoded data link for example can be a uniquely paired communications path or channel between communicators only accessible by knowing the current network identification information. Determination of a required data link can be based on such parameters but not limited to: distance, direction, link integrity, interaction, coordination, data transfer, etc. Setup of an encoded data link is performed using the control channel whereby each local communicator (service user) sends control information including a channel request back to the network identification information broadcaster (service provider). Based on this transaction, encoded channels are initiated between the service user and provider as shown in FIG. 1. Vehicle 100 communicates with vehicle 104 via encoded data link 112, vehicle 106 via link 114 and fixed station 102 via link 110. Similarly, vehicle 104 communicates with vehicle 106 via link 116 and fixed station 102 via link 118. Finally, vehicle 106 communicates with fixed station 102 via link 126.

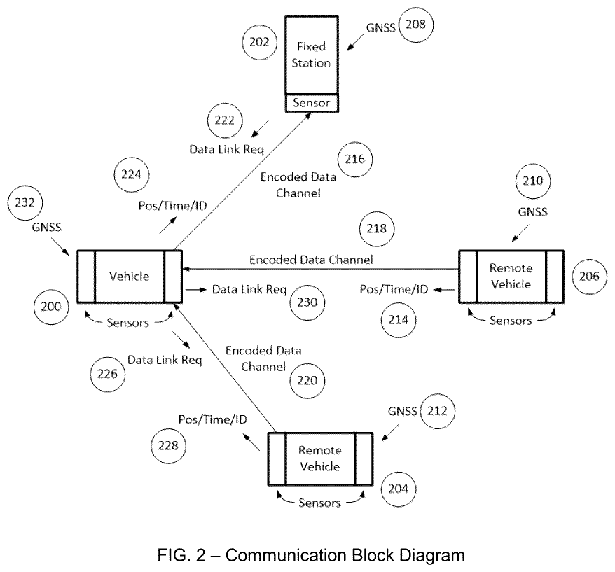

The present invention preferred embodiment as shown in FIG. 2 provides more detail into the communication between four local proximity communicator stations. In this figure, each communicator station transmits or receives control or encoded data information using sensor equipment built into each vehicle or fixed position station. Example industry standard sensors found in the art capable of information transfer include but are not limited to: RF transceiver types such as Cellular, Dedicated short range communications (DSCR), Mobile wireless broadband (MWB), Satellite and other sensor types such as Millimeter wave radar, Infrared. Vehicle 200 acts as both a service user/provider; while remote vehicle 206 and vehicle 204 are service providers; and fixed station 202 is a service user. An example application could have vehicle 200 streaming sensor data from vehicles 206 and 204 while interacting with fixed station 202 for a billing service. In setting up the encoded data channels, vehicle 200 receives GNSS information 232 and then broadcasts pos/time/ID derived identification information 224 onto the control channel. Similarly, vehicle 206 also receives GNSS information 210 and broadcasts pos/time/ID derived identification information 214 onto the control channel while vehicle 204 receives GNSS information 212 and broadcasts pos/time/ID derived identification information 228 on the control channel. Vehicle 200 receives pos/time/ID derived identification information 214 and sends control information data link request 230 to vehicle 206 to initiate encoded data channel 218. Vehicle 200 also receives pos/time/ID derived identification information 228 and sends control information data link request 226 to initiate encoded data channel 220. Fixed station 202 receives pos/time/ID derived identification information 224 and sends control information data link request 222 to initiate encoded data channel 216. Each of the encoded data channels 218, 220 and 222 between service user and provider are unique being based on the pos/time/ID derived identification information sent by the service provider. The encoding of each encoded data channel 218, 220 and 222 can be changed at anytime by transferring updated pos/time/ID derived identification information from service provider to user. This allows secure communications between communicators based on the encoding constantly changing thereby being difficult to intercept.

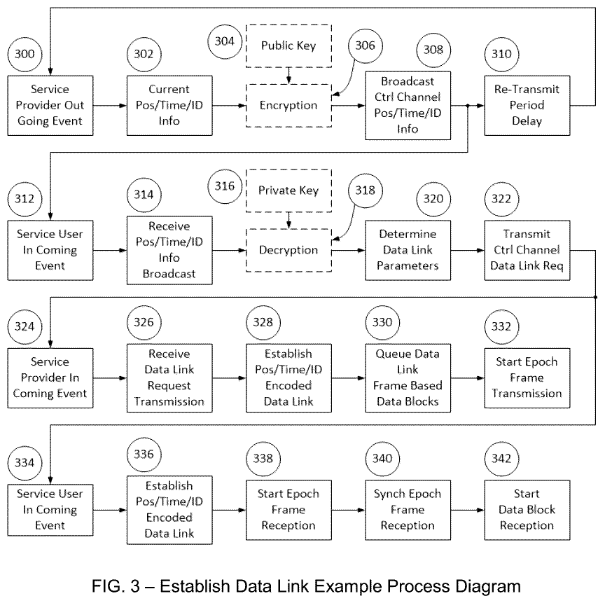

FIG. 3 shows an example of process steps used to establish the encoded data link between a service provider and service user. Service provider event 300 initiates the sequence to broadcast pos/time/ID derived identification information. The current pos/time/ID identification information is derived from GNSS information in step 302. Encryption step 306 using public key 304 is an optional step to encrypt the identification information broadcast on the common control channel. Broadcast of pos/time/ID derived identification information on the common control channel is performed in step 308 whereby a period delay 310 is started to schedule a later broadcast event 300. Service user event 312 is initiated upon reception of pos/time/ID derived identification information 314 from the common control channel. Decryption step 318 using private key 316 is an optional step to decrypt the identification information received on the common control channel. Step 320 determines the data link parameters for the control information data link request transmitted on the common control channel 322. Service provider event 324 is initiated upon reception of a control information data link request 326 on the common control channel. The data link parameters determined in step 320 is used to establish a pos/time/ID encoded data link 328. Step 330 forms a queue of frame based data blocks to be transmitted on the encoded data link. Step 332 starts an epoch based frame transmission of data across the encoded data link. Service user event 334 is initiated upon transmission of the data link request to start encoded channel data reception. Step 336 uses the data link parameters determined in step 320 to establish a pos/time/ID encoded data link. Epoch data frame reception of the encoded data channel is started 338 and synchronized 340 prior to data block reception 342. Termination of the encoded data channel can be initiated by the service provider based on the service being completed.

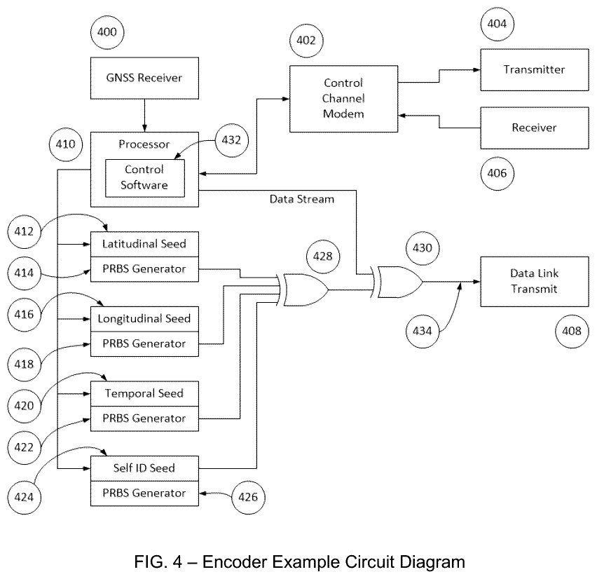

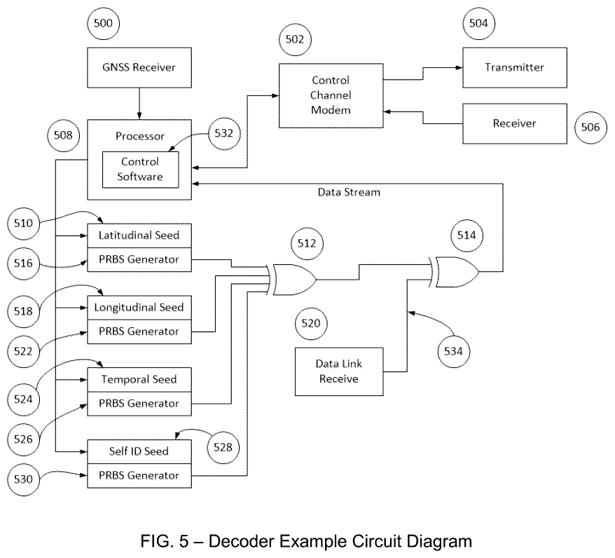

An example channel encoder circuit based on position, time and ID network identification information for the preferred embodiment is presented in FIG. 4. This example based on Code Division Multiple Access (CDMA) may be replaced with any channel multiplexing method including but not limited to: Time Division Multiple Access (TDMA) and Frequency Division Multiple Access (FDMA). Additionally, this encoder example is shown based on a horizontal datum coordinate system (Latitude/Longitude) but can be simply modified to include a vertical datum (altitude) component. GNSS receiver 400 provides the communicator's current geodetic datum information. An example GNSS receiver reporting geodetic datum information could utilize NEMA 183 messages. In these messages, strings representing latitude (ddmm.mmmm plus N/S indicator), longitude (dddmmm.mmmm plus E/W indicator) and time (hhmmss.ss) can all be converted to a 32-bit fixed point format. These three 32-bit numbers plus a 32-bit self ID field can be used as seed values (FIG. 4 412, 416, 420, 424 and FIG. 5 510, 518, 524, 528) for the PRBS generators. Control channel modem 402 provides processor 410 access to the common control channel in conjunction with transmitter 404 and receiver 406. Control software 432 executes on processor 410 to operationally control the encoder circuit. Latitudinal seed 412, longitudinal seed 416, temporal seed 420 and self ID seed 424 are calculated by control software 432 based on identification information received from the control channel. The seed values are loaded into PRBS generator circuits 414, 418, 422 and 426 to create multiple pseudo random bit streams. Logic element 428 combines the multiple PRBS into a single PRBS used to encode the data link. Finally, logic element 430 creates an encoded data stream 434 from a non-encoded data stream provided by control software 432. The encoded data stream 434 is transmitted on the data link by transmitter 408.

An example channel decoder circuit based on position, time and ID network identification information for the preferred embodiment is presented in FIG. 5. This example based on Code Division Multiple Access (CDMA) may be replaced with any channel multiplexing method including but not limited to: Time Division Multiple Access (TDMA) and Frequency Division Multiple Access (FDMA). Additionally, this encoder example is shown based on a horizontal datum coordinate system (Latitude/Longitude) but can be simply modified to include a vertical datum (altitude) component. GNSS receiver 500 provides the communicator's current geodetic datum information. Control channel modem 502 provides processor 508 access to the common control channel in conjunction with transmitter 504 and receiver 506. Control software 532 executes on processor 508 to operationally control the decoder circuit. Latitudinal seed 510, longitudinal seed 518, temporal seed 524 and self ID seed 528 are calculated by control software 532 based on identification information received from the control channel. The seed values are loaded into PRBS generator circuits 510, 518, 524 and 530 to create multiple pseudo random bit streams. Logic element 512 combines the multiple PRBS into a single PRBS used to decode the data link. Finally, logic element 514 removes the PRBS to create a decoded data stream as based on encoded data stream 534 provided by data link receiver 520. The decoded data stream is sent to control software 532.

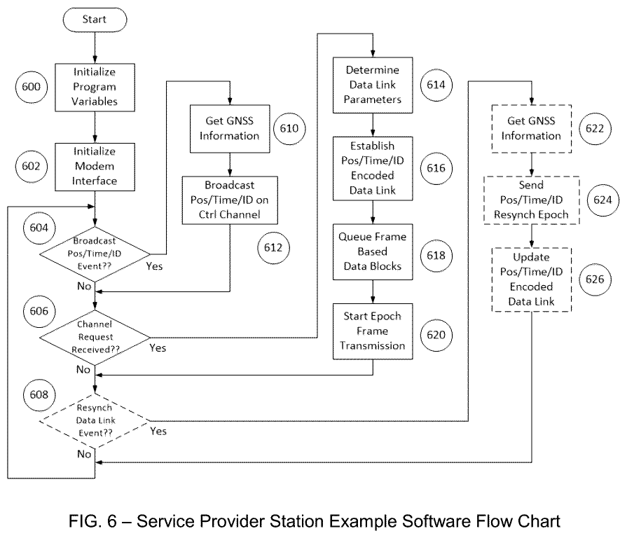

FIG. 6 shows an example software flow chart for the service provider control software 432 of the preferred embodiment. Execution begins at the “Start” label first initializing program variables 600 and initializing the modem interface 602. Decision block 604 determines if a pos/time/ID broadcast event has been scheduled. If so, the latest GNSS information is retrieved 610 and broadcast as pos/time/ID on the control channel 612. If not, decision block 606 determines if a channel request has been received on the control channel from a service user. If so, the data link parameters are determined 614 and the pos/time/ID encoded data link is established 616 by seeding PRBS generators 414, 418, 422 and 426. Data blocks are then queued into frames 618 and the epoch frame transmission is started 620. If no channel request has been received, decision block 608 determines if an optional data link resynchronization event has been scheduled. If so, the current GNSS information is retrieved 622 and sent as updated pos/time/ID control information in a resynchronization epoch 624 to the service user. Finally, the pos/time/ID encoded data link is updated 626 by reseeding PRBS generators 414, 418, 422 and 426.

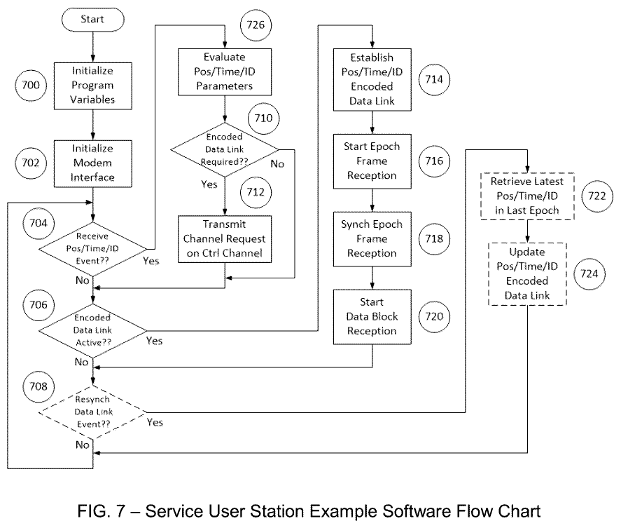

FIG. 7 shows an example software flow chart for the service user control software 532 of the preferred embodiment. Execution begins at the “Start” label first initializing program variables 700 and initializing the modem interface 702. Decision block 704 determines if a pos/time/ID broadcast event has been received. If so, the pos/time/ID parameters are evaluated to determine if an encoded data link is required. This determination can be based on such parameters but not limited to: distance, direction, interaction, coordination, data transfer, etc. If an encoded channel is required 710, a channel request is transmitted on the control channel 712. Next, decision block 706 follows and determines if an encoded data link has been activated. If so, the pos/time/ID encoded data link is established 714 by seeding PRBS generators 516, 522, 526 and 530. Epoch data frame reception of the encoded data channel is started 716 and synchronized 718 prior to data block reception 720. Termination of the encoded data channel can be initiated by the service provider based on the service being completed. Decision block 708 determines if an optional data link resynchronization event has been received. If so, updated pos/time/ID control information is retrieved from a resynchronization epoch 722. Finally, the pos/time/ID encoded data link is updated 724 by reseeding PRBS generators 516, 522, 526 and 530.

An alternative embodiment of the present invention comprises replacing the static IEEE 801.11 defined MAC address with a dynamic or changing value based on geodetic datum. A dynamic value replacing the static network identifier is especially useful for securing Non-IP routed network communications. In this manner, the network identification of a network communicator could be changed dynamically providing a method of secure communications. The dynamic network identification for a communicator would be derived from a combination of their geodetic position, time and self ID as described with reference to FIG. 4. As described, the resultant 128 bit network identification would need to be reduced down to a unique 48 bit sized representation to be compatible with existing systems. This reduction in the numerical size could be achieved by a hashing function or some other method.

An exemplary application of the present invention would consist of a fixed position communication station acting as the service user to moving vehicular communication stations providing a service. Various examples of a fixed position communication station include but are not limited to: toll collection station, parking lot entry/exit station, restaurant/store drive thru station, etc. In this example, an automated fixed position toll station receives network identification information broadcast by vehicles moving past the station. The toll station will request an encoded channel with each passing vehicle to procure a toll payment. Since each vehicle's pos/time/ID used within the current network identification will be different, each encoded channel will be uniquely and securely paired. The network identification information also has the properties of being temporary and of one time usage. In comparison, a static MAC address is permanently assigned to a communicator and used for every interaction. This opens the possibility of a bad actor cloning the MAC address of another network communicator and impersonating them on the network. The problem is magnified within open air systems whereby MAC address transmissions are freely accessible to any user within receiving range of the signal. For purpose of this toll station example, a bad actor could receive and clone the MAC address of another user. This would allow the bad actor to freely interact to toll station inquires using a cloned MAC address and cheat the system.

The claimed invention is:

1. A system comprising:
a. a communication network coupled to at least two communication stations, the communication network routing data in response to the communication stations;
b. a first communication station coupled to the communication network, the first communication station transmitting and receiving data in response to the communication network;
c. a second communication station coupled to the communication network, the second communication station transmitting and receiving data in response to the communication network;
d. wherein the first communication station is configured to receive GNSS information and derive first network identification information based on geodetic datum information; and
e. wherein the second communication station is configured to receive GNSS information and derive second network identification information based on geodetic datum information.

2. The system of claim 1, wherein each communication station is configured to broadcast network identification information onto the communications network and receive broadcast network identification information from the communications network.

3. The system of claim 2, wherein each communication station is configured to establish an encoded data link based on network identification information.

4. The system of claim 2, wherein each communication station is configured to perform network communications using a RF transceiver sensor.

5. The system of claim 2, wherein each communication station is configured to perform network communications using an infrared sensor.

6. The system of claim 2, wherein each communication station is configured to perform network communications using a radar sensor.

7. A method comprising:
a. routing data on a communication network in response to at least two communication stations;
b. transmitting and receiving data by a first communication station in response to the communication network;
c. transmitting and receiving data by a second communication station in response to the communication network;
d. generating first communication station network identification information derived from geodetic data information in response to GNSS information; and
e. generating second communication station network identification information derived from geodetic data information in response to GNSS information.

8. The method of claim 7, further comprising broadcasting network identification information by a communication station onto the communications network and receiving broadcast network identification information by a communication station from the communications network.

9. The method of claim 8, further comprising establishing an encoded data link by a communication station based on network identification information.

10. A system comprising:
a. a fixed position communication station coupled to a communication network, the fixed position communication station transmitting and receiving data in response to the communication network;
b. a mobile communication station coupled to a communication network, the mobile communication station transmitting and receiving data in response to the communication network;
c. wherein the fixed position communication station is configured to receive geodetic datum derived network identification information from the mobile communication station, respond with network control information and establish an encoded data link with the mobile communication station; and
d. wherein the mobile communication station is configured to receive network control information from the fixed position communication station and establish an encoded data link with the fixed position communication station.

11. The system of claim 10, wherein the fixed position communication station comprises a toll collection station.

12. The system of claim 10, wherein the fixed position communication station comprises a parking lot entry/exit station.

13. The system of claim 10, wherein the fixed position communication station comprises a restaurant/store drive thru station.
